(19) United States
(12) Patent Application Publication
(10) Pub. No.: US 2004/0023168 A1
(43) Pub. Date: Feb. 5, 2004

(54) Colour photographic developing concentrate

(75) Inventors: Ralf Wichmann, Gladbach (DE); Frank Dovecar, Leverkusen (DE)

Correspondence Address: CONNOLLY BOVE LODGE & HUTZ, LLP, P O BOX 2207, WILMINGTON, DE, 19899, US

(73) Assignee: Agfa-Gevaert

(21) Appl. No.: 10/622,594

(22) Filed: Jul. 18, 2003

(30) Foreign Application Priority Data
Jul. 19, 2002 (DE) 102 32 903.6

(51) Int. Cl. G03C 7/407; G03C 7/413

(52) U.S. Cl. 430/466; 430/490; 430/493; 430/435

(57) ABSTRACT

A single-part colour developing concentrate with a pH greater than or equal to 7 which contains at least 0.02 mol of a colour developer substance and at least 0.015 mol of an antioxidant per litre, characterised in that the concentrate contains 0.05 to 35 g per litre of a wetting agent soluble in water in this amount, is distinguished by very good stability in storage at low temperatures and the discharge behaviour from the concentrate bottle is considerably improved and soiling of the processing equipment is avoided. Furthermore, the optical brightener precipitation occurring in practice in the bleach fixing bath is also prevented.

Single-part colour developing concentrate with a pH greater than or equal to 7, which contains at least 0.02 mol of a colour developer substance and at least 0.015 mol of an antioxidant per litre.

The developing solution for the development of colour photographic materials, in particular for the development of colour photographic paper, is prepared or continuously replenished from concentrates which contain the necessary components.

It has proven to be advantageous to use single-part concentrates, as errors in handling when preparing or replenishing a developing solution may consequently be avoided.

Concentrates of this type may, for example, be single-phase, as described in U.S. Pat. No. 6,077,651, or multi-phase, as described in DE 100 05 498.

Wetting agents are used in photographic processing, primarily as an additive to the final bath in order to facilitate drying. Fluorinated wetting agents are known from DE 3 938 573 as an additive of black/white developing solutions for preventing white flecks, in particular in X-ray material.

Ready-to-use developer and regenerator solutions are described in EP 436 947 which have a low sulphite content and contain between 0.5 and 20 g of a wetting agent per litre of solution. The wetting agent is added directly to the ready-to-use solutions and brings about a reduction in the deposits in the processing equipment and a reduction in the undesired coloration of the processed material. The use of the wetting agent in developing concentrates is not described.

Three different concentrates are conventionally used to prepare the developing solution as certain components of the developing bath are not compatible with one another over a prolonged period. Therefore, for example one concentrate contains the antioxidant, an auxiliary solvent and an optical brightener, a second concentrate contains the colour developer substance, for example4-(N-ethyl-N-2-methylsulphonylaminoethyl)-2-methyl-phenylenediaminesesquisulphate (CD-3) or 4-(N-ethyl-N-2-hydroxyethyl)-2-methylphenylenediaminesulphate (CD-4) and a third concentrate contains the buffer substance, alkali and a demineralising agent.

In recent years single-part single- or multi-phase developing concentrates have increasingly been offered for sale. These have the advantage that they simplify preparation of the working solution and errors when preparing or replenishing a developing solution may be avoided.

A drawback of the single-part concentrates is, however, their still unsatisfactory stability at low temperatures, in particular at temperatures below 0° C., which manifests itself in precipitation of the components. Precipitation occurs frequently on the phase interface specifically in two-phase concentrates and cannot dissolve after emptying of the concentrate bottles and dilution with water to form the working solution and may lead to clogging of the regenerator pumps.

Packing drums are increasingly used in modern minilabs for a plurality of processing chemical concentrates in which the concentrate bottles, which are made of plastics material, are stored upside down in a common box in the machine and the discharge apertures are located at the same height (viewed from the base of the box). If required, the seal with which the upside down bottles are closed is pierced by a spike on the machine and the concentrates flow via a plastic tube into a suitable regenerator reservoir in the machine. After the concentrates have drained off, the boxes with the empty box bottles are removed from the equipment and then disposed of. For this purpose it is necessary for the concentrates to drain off quickly and fully from the bottles and for no concentrate residue to remain in the bottles for environmental reasons.

When using colour developing solutions which are prepared from single-part concentrates, or which are regenerated by using such concentrates, considerable drawbacks occur, however. These single- or multi-phase single-part concentrates often contain a high proportion of highly viscous organic solvents to keep the contained components, in particular the optical brightener or the colour developer substance, in the concentrate or in the regenerator in solution and to avoid precipitation. In addition, they are generally very highly concentrated in order to be able to achieve high dilution of the concentrate and a large extent of the chemical packing drum. The discharge rate of the single-part concentrates is greatly reduced, probably owing to the high viscosity, so prolonged preparation times result for the working solution and further working with the minilab is not possible during this period.

A particular drawback is that, when using the abovementioned packing drum, chemical residues remain in the developing concentrate bottle after emptying and consequently disposal of the entire packing drum is made more difficult for environmental reasons.

In addition, when using the described packing drum with single-part developing concentrates, soiling and crystallisation are observed at the coupling points of the processing equipment where the developing concentrate container is docked on the equipment. Such soiling leads to high expenditure for cleaning and may impair operation of the equipment.

A further drawback of single-part developing concentrates consists in that, after preparing the working solutions from the concentrates, optical brightener precipitation may occur in the bleach fixing bath tank in practical operation and may lead to clogging of the filter and pumps in the bleach fixing bath. This effect is particularly pronounced with low regeneration quotas, in particular with regeneration quotas of the developing solution of less than 120 ml per m².

The object of the invention was to eliminate said drawbacks. Surprisingly this is achieved if a wetting agent is added to the single-part concentrate.

The invention therefore relates to a single-part colour developing concentrate with a pH greater than or equal to 7 which contains at least 0.02 mol of a colour developer substance and at least 0.015 mol of an antioxidant per litre, characterised in that the concentrate contains 0.05 to 35 g and preferably 0.3 to 30 g per litre of a wetting agent which is water-soluble in this amount.

The wetting agent according to the invention may be cationic, anionic, amphoteric or non-ionic. Suitable wetting agents are described, for example, in EP 436 947.

The advantages according to the invention are particularly pronounced with non-ionic wetting agents, in particular those with polyalkylene oxide structural units and of these in particular those of general structural formulae (I) to (IV):

R¹—O—(CH₂CH₂)_{w}—H (I),

wherein

R¹ represents linear alkyl with 16 to 18 carbon atoms and

w represents an integer from 10 to 80, in particular from 10 to 30

R²—O—(CH₂CH₂O)ₓ—H (II),

wherein

R² represents i-C₁₃H₂₇ and

x represents an integer from 2 to 20, in particular from 5 to 10,

R³—O—(CH₂CH₂O)_{y}—H (III),

wherein

R³ represents linear alkyl with 12 to 18 carbon atoms and

y represents an integer from 2 to 10, in particular from 6 to 8

and

R⁴—O—(CH₂CH₂O)_{z}—H (IV),

wherein

R⁴ represents n-C₉H₁₉-phenyl and

z represents an integer from 6 to 30, in particular from 10 to 20.

Suitable wetting agents of structural formulae (I) to (IV) are mentioned in the following.

| | |
|---|---|
| I-1 | n-C₁₈H₃₇—O—(CH₂CH₂—O)₂₅H |
| I-2 | n-C₁₇H₃₅—O—(CH₂CH₂—O)₂₅H |
| I-3 | n-C₁₆H₃₃—O—(CH₂CH₂—O)₂₅H |
| I-4 | n-C₁₈H₃₇—O—(CH₂CH₂—O)₁₁H |
| I-5 | n-C₁₇H₃₅—O—(CF₂CH₂—O)₁₁H |
| I-6 | n-C₁₆H₃₃—O—(CH₂CH₂—O)₁₁H |
| I-7 | n-C₁₈H₃₇—O—(CH₂CH₂—O)₁₈H |
| I-8 | n-C₁₁H₃₅—O—(CH₂CH₂—O)₁₈H |
| I-9 | n-C₁₆H₃₃—O—(CH₂CH₂—O)₁₈H |
| I-10 | n-C₁₈H₃₇—O—(CH₂CH₂—O)₅₀H |
| I-11 | n-C₁₇H₃₅—O—(CH₂CH₂—O)₅₀H |
| I-12 | n-C₁₆H₃₃—O—(CH₂CH₂—O)₅₀H |
| I-13 | n-C₁₈H₃₇—O—(CH₂CH₂—O)₈₀H |
| I-14 | n-C₁₇H₃₅—O—(CH₂CH₂—O)₈₀H |
| I-15 | n-C₁₆H₃₃—O—(CH₂CH₂—O)₈₀H |
| II-1 | C₁₃H₂₇—O—(CH₂CH₂—O)₃H |
| II-2 | C₁₃H₂₇—O—(CH₂CH₂—O)₈H |
| II-3 | C₁₃H₂₇—O—(CH₂CH₂—O)₁₅H |
| II-4 | C₁₃H₂₇—O—(CH₂CH₂—O)₂₅H |
| III-1 | n-C₁₂H₂₅—O—(CH₂CH₂—O)₂H |
| III-2 | n-C₁₃H₂₅—O—(CH₂CH₂—O)₂H |
| III-3 | n-C₁₄H₂₉—O—(CH₂CH₂—O)₂H |
| III-4 | n-C₁₅H₃₁—O—(CH₂CH₂—O)₂H |
| III-5 | n-C₁₆H₃₃—O—(CH₂CH₂—O)₂H |
| III-6 | n-C₁₇H₃₅—O—(CH₂CH₂—O)₂H |
| III-7 | n-C₁₈H₃₇—O—(CH₂CH₂—O)₂H |
| III-8 | n-C₁₂H₂₅—O—(CH₂CH₂—O)₅H |
| III-9 | n-C₁₃H₂₅—O—(CH₂CH₂—O)₅H |
| III-10 | n-C₁₄H₂₉—O—(CH₂CH₂—O)₅H |
| III-11 | n-C₁₅H₃₁—O—(CH₂CH₂—O)₅H |
| III-12 | n-C₁₆H₃₃—O—(CH₂CH₂—O)₅H |
| III-13 | n-C₁₇H₃₅—O—(CH₂CH₂—O)₅H |
| III-14 | n-C₁₈H₃₇—O—(CH₂CH₂—O)₅H |
| III-15 | n-C₁₂H₂₅—O—(CH₂CH₂—O)₁₀H |
| III-16 | n-C₁₃H₂₇—O—(CH₂CH₂—O)₁₀H |
| III-17 | n-C₁₄H₂₉—O—(CH₂CH₂—O)₁₀H |
| III-18 | n-C₁₅H₃₁—O—(CH₂CH₂—O)₁₀H |
| III-19 | n-C₁₆H₃₃—O—(CH₂CH₂—O)₁₀H |
| III-20 | n-C₁₇H₃₅—O—(CH₂CH₂—O)₁₀H |
| III-21 | n-C₁₈H₃₇—O—(CH₂CH₂—O)₁₀H |

| | |
|---|---|
| 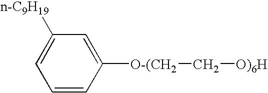 | IV-1 |
| 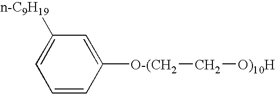 | IV-2 |
| 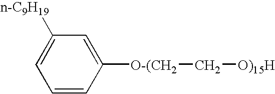 | IV-3 |
| 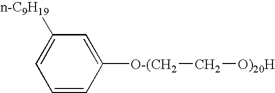 | IV-4 |
| 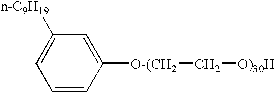 | IV-5 |
| 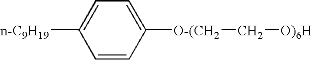 | IV-6 |
| 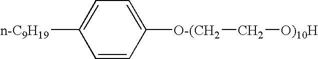 | IV-7 |
| 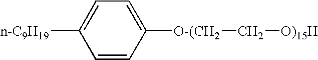 | IV-8 |
| 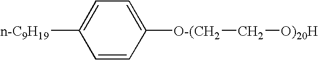 | IV-9 |
| 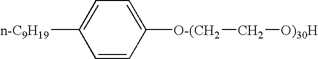 | IV-10 |
| 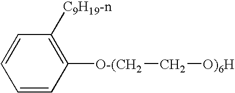 | IV-11 |
| 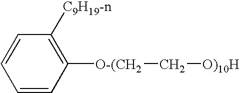 | IV-12 |
| 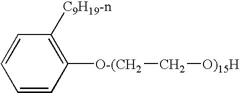 | IV-13 |
| 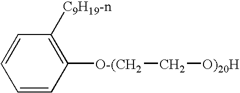 | IV-14 |
| 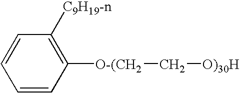 | IV-15 |

The colour developer substance is preferably 4-(N-ethyl-N-2-methyl-sulphonylaminoethyl)-2-methylphenylenediamine.

A concentrate according to the invention is an aqueous preparation of which one part by volume is diluted with 1 to 39 parts by volume water in order to produce a ready-to-use solution. It preferably contains at least 50 mmol and particularly preferably 70 to 700 mmol colour developer substance/l.

The colour developer substance is preferably not added to the concentrate as sulphate, as is conventional in CD-3 or CD-4, but as a phosphate, p-toluenesulphonate, chloride or as a free base, the phosphate and in particular the free base being particularly preferred.

CD-3 (sesquisulphate) or CD-4 (sulphate) may also be used and the sulphate ions may be separated by precipitation with metal ions and, for example, filtration.

In a preferred embodiment the concentrate contains at most 0.1 mol, preferably at most 0.05 and particularly preferably at most 0.02 mol sulphate ions/l.

The concentrate according to the invention also contains the conventional chemicals required for development of a colour photographic material, such as a demineralising agent, an optical brightener, a complexing agent, a buffer system and alkali. In a particular preferred embodiment of the invention the concentrate contains an anti-foaming agent. The desired final volume is adjusted by adding water, for which purpose demineralised water is preferably used.

In a preferred embodiment of the invention the colour developing concentrate is a multi-phase, in particular two-phase, concentrate which is produced as described in DE 100 05 498, but to which the wetting agent according to the invention is added at any time during production.

The concentrate does not contain any undissolved components and is preferably precipitation-free for at least one month during storage, particularly preferably also during storage below 0° C., in particular between 0° C. and −7° C.

In a preferred embodiment the concentrate also contains a minimum amount of one or more water-soluble organic solvents.

In a preferred embodiment the organic solvent contains a mixture of polyethylene glycols of different molecular weight from monoethylene glycol through to polyethylene glycol with a mean molecular weight of 20,000, for example a mixture of diethylene glycol, polyethylene glycol with the mean molecular weight of 400 and polyethylene glycol with the mean molecular weight of 15,000. The mean molecular weights are weight averages.

In this way optimal adjustments may be produced for precipitation-free, single-part, optionally even single-phase developing concentrates.

The polyethylene glycol mixture constitutes, in particular, at least 90 vol % of the organic solvent.

Examples of water-soluble organic solvents are those from the series of glycols, polyglycols, alkanolamines, aliphatic and heterocyclic carbonamides, aliphatic and cyclic monoalcohols, wherein 50 to 95% by weight, preferably 60 to 90 by weight of the total of water and water-soluble solvents are water.

Suitable water-soluble solvents are, for example, carboxylic acid amide and urea derivatives such as dimethylformamide, methylacetamide, dimethylacetamide, N,N′-dimethylurea, tetramethylurea, methane sulphonic acid amide, dimethylethylene urea, N-acetylglycine, N-valeramide, isovaleramide, N-butyramide, N,N-dimethylbutyramide, N-(2-hydroxyphenyl)-acetamide, N-(2-methoxyphenyl)-acetamide, 2-pyrrolidinone, ε-caprolactam, acetamilide, benzamide, toluene sulphonic acid amide, phthalimide;

aliphatic and cyclic alcohols, for example isopropanol, tert.-butylalcohol, cyclohexanol, cyclohexane methanol, 1,4-cyclohexane dimethanol;

aliphatic and cyclic polyalcohols, for example glycols, polyglycols, polywaxes, trimethyl-1,6-hexane diol, glycerol, 1,1,1-trimethylolpropane, pentaerythritol, sorbitol;

aliphatic and cyclic ketones, for example acetone, ethyl-methyl-ketone, diethylketone, tert.-butyl-methyl-ketone, diisobutylketone, acetylacetone, acetonylacetone, cyclopentanone, acetophenol;

aliphatic and cyclic carboxylic acid esters, for example triethoxymethane, acetic acid methylester, allyl acetate, methylglycol acetate, ethylene glycol diacetate, glycerine-1-acetate, glycerol diacetate, methylcyclohexyl acetate, salicylic acid methylester, salicylic acid phenylester;

aliphatic and cyclic phosphonic acid esters, for example methylphosphonic acid dimethylester, allylphosphonic acid diethylester;

aliphatic and cyclic oxy-alcohols, for example 4-hydroxy-4-methyl-2-pentanone, salicylicaldehyde;

aliphatic and cyclic aldehydes, for example acetaldehyde, propanal, trimethylacetaldehyde, crotonicaldehyde, glutaricaldehyde, 1,2,5,6-tetrahydrobenzaldehyde, benzaldehyde, benzene propane, terephthalicaldehyde;

aliphatic and cyclic oximes, for example butanone oxime, cyclohexanone oxime;

aliphatic and cyclic amines (primary, secondary or tertiary), for example ethylamine, diethylamine, triethylamine, dipropylamine, pyrrolidine, morpholine, 2-aminopyrimidine;

aliphatic and cyclic polyamines (primary, secondary or tertiary), for example ethylenediamine, 1-amino-2-diethylaminoethane, methyl-bis-(2-methylamino-ethyl)amine, permethyl-diethylenetriamine, 1,4-cyclohexanediamine, 1,4-benzenediamine;

aliphatic and cyclic hydroxyamines, for example ethanolamine, 2-methylethylamine, 2-methylaminoethanol, 2-(dimethylamino)ethanol, 2-(2-dimethylamino-ethoxy)-ethanol, diethanolamine, N-methyldiethanolamine, triethanolamine, 2-(2-aminoethylamino)-ethanol, triisopropanolamine, 2-amino-2-hydroxymethyl-1,3-propanediol, 1-piperidine ethanol, 2-aminophenol, barbituric acid, 2-(4-aminophenoxy)-ethanol, 5-amino-1-naphthol.

The processing conditions, suitable colour developer substances, suitable buffer substances, suitable demineralising agents, suitable optical brighteners, auxiliary developers, development accelerators and anti-fogging agents are described in Research Disclosure 37 038 (February 1995) on pages 102 to 107.

Multi-phase means that the concentrate contains two or more liquid phases, but no precipitation. The liquid phases are, for example, an aqueous and an organic phase.

Suitable antioxidants are compounds of formulae (I), (II) and (III).

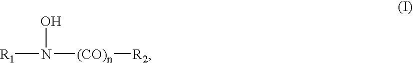

wherein

R₁ represents optionally substituted alkyl,

R₂ represents optionally substituted alkyl or optionally substituted aryl and

n represents 0 or 1

preferably those in which at least one of the radicals R₁ and R₂ contains at least one —OH—, —COOH— or —SO₃H group;

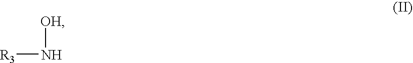

wherein

R₃ represents an alkyl or acyl group;

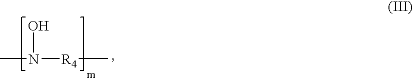

wherein

R₄ represents an alkylene group optionally interrupted by O atoms and

m represents a number of at least 2.

The alkyl groups R₁, R₂, R₃, the alkylene group R₄ and the aryl group R₂ may have further substituents beyond the indicated substitution.

Examples of suitable antioxidants are

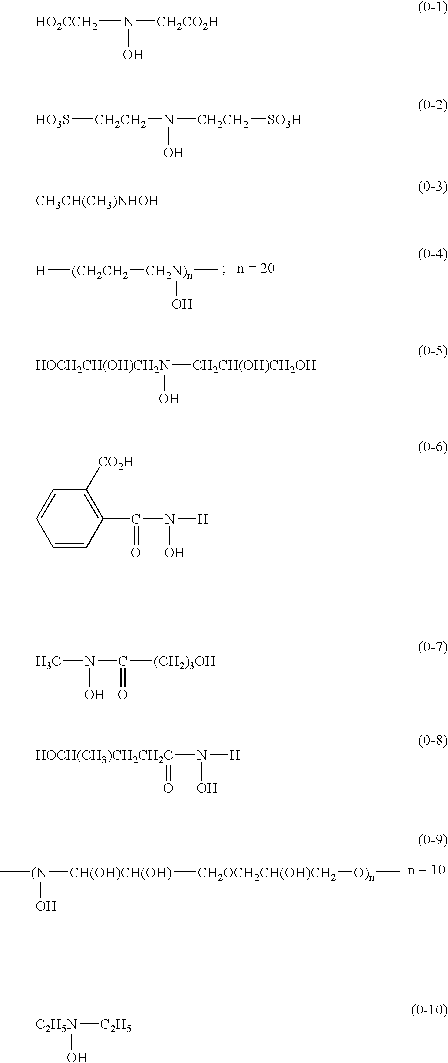

When diluting the concentrate with water to produce the ready-to-use colour developer or the regenerator, any phase interfaces present disappear; the ready-to-use developer is single-phase.

In a further advantageous embodiment of the invention the concentrate is an homogeneous, single-phase concentrate which is produced as described in U.S. Pat. No. 6,077,651, but to which the wetting agent according to the invention is added at any time during production.

These single-phase concentrates have a pH value of about 7 to about 13 and have a comparatively high content of water-miscible hydroxyl group-carrying, in particular straight chain organic solvents with a molecular weight of about 50 to 200 and a buffer substance soluble therein. The weight ratio of water to the organic solvent is preferably between 15:85 and 50:50.

The buffer substance preferably has a pKa value between 9 and 13. Suitable buffer substances are, for example carbonates, borates, tetraborates, salts of glycine, triethanolamine, diethanolamine, phosphates and hydroxybenzoates, of which alkali metal carbonates, such as sodium carbonate and potassium carbonate, are preferred.

When producing the single-part, single-phase concentrate, an aqueous solution which contains the sulphate of the colour developer and optionally further additives, is combined with an alkali metal base and subsequently precipitated by addition of the organic solvent alkali metal sulphate. The alkali metal sulphate is separated by any suitable separating technique, for example by filtering.

Particularly suitable organic solvents for this purpose are, for example polyols and of these, in particular, glycols such as ethylene glycol, diethylene glycol and triethylene glycol, polyhydroxyamines and of these, in particular, polyalkanolamines and alcohols, in particular ethanol and benzylalcohols. The organic solvent best suited for the production of single-phase, single-part concentrates is diethyleneglycol.

The invention also relates to a method for processing a colour photographic silver halide material, characterised in that the developing solution is prepared from a concentrate and/or is regenerated with a concentrate in which the concentrate is a single-part colour developing concentrate with a pH greater than or equal to 7, which contains at least 0.02 mol of a colour developer substance and at least 0.015 mol of an antioxidant per litre, characterised in that the concentrate contains at least 0.05 g per litre of a wetting agent which is water-soluble in this amount.

In preferred embodiments of the method, the entrainment of the developing solution into the following baths is less than 60 ml per m² of processed material, the temperature of the developing solution is between 20 and 50° C., the regeneration quota of the developing solution is less than 120 ml per m² of processed material and the development time is less than 60 s.

Further advantageous embodiments of the invention may be found in the claims.

### EXAMPLES

### Concentrate K-1 (Comparison)

Three-part developing concentrate

Part A: K-1A

| | |
|---|---|
| Polyethylene glycol, mean molecular weight 400 | 300 ml |
| Diethylhydroxylamine, 85% by weight | 120 ml |
| Aqueous solution (DEHX solution) | |
| Optical brightener | 20 g |
| adjust pH to 10 with KOH and top up to 1 litre with water | |

Part B: K-1B

| | |
|---|---|
| CD3 | 280 g |
| Sodium disulphite | 10 g |
| top up to 1 litre with water | |
| approx. pH 1 is automatically obtained | |

Part C: K-1C

| | |
|---|---|
| Potassium hydroxide | 65 g |
| Potassium carbonate | 600 g |
| EDTA | 3 g |
| top up to 1 litre with water | |
| approx. pH 14 is automatically obtained | |

Concentrate K-2 (Comparison)
Single-part, multi-phase developing concentrate
Diethyihydroxylamine, 85% by weight aqueous solution

| | |
|---|---|
| (DEHX-solution) | 60 ml |
| CD-3-phosphate | 70 g |
| Caprolactam | 100 g |
| Triethanolamine | 80 ml |
| Optical brightener | 10 g |
| EDTA | 30 g |
| Potassium carbonate | 165 g |
| KOH | 42 g |
| adjust pH to 11.2 with KOH and top up to 1 litre with water. | |

Concentrate K-3 (Comparison)
Single-part, multi-phase developing concentrate

| | |
|---|---|
| Antioxidant O-2 | 60 g |
| CD-3-phosphate | 70 g |
| Caprolactam | 100 g |
| Triethanolamine | 80 ml |
| Optical brightener | 10 g |
| EDTA | 30 g |
| Potassium carbonate | 165 g |
| KOH | 42 g |
| adjust pH to 11.2 with KOH and top up to 1 litre with water. | |

Concentrate K-4 (Comparison)
Single-part, multi-phase developing concentrate

| | |
|---|---|
| DEHX solution | 70 ml |
| CD-3 | 66 g |
| Diethylene glycol | 100 ml |
| Polyethylene glycol, \overline{M} w 400 | 50 ml |
| Polyethylene glycol, \overline{M} w 6000 | 50 g |
| Optical brightener | 10 g |
| EDTA | 30 g |
| Potassium carbonate | 240 g |
| KOH | 33.7 g |
| adjust pH to 11.2 with KOH and top up to 1 litre with water. | |

CD-3 is initially mixed with KOH and DEHX solution in water. The K₂SO₄ precipitating in the process is filtered off. The remaining components are then added.

Concentrate K-S (Comparison)

| | |
|---|---|
| DEHX solution | 35 ml |
| CD-3 | 74 g |
| Diethylene glycol | 60 ml |
| Polyethylene glycol Mw 400 | 140 ml |
| Optical brightener | 10 g |
| Beiclene 200-solution (polymaleic acid anhydride) | 50 ml |
| Potassium carbonate | 160 g |
| KOH | 66 g |
| adjust pH to 12.5 with KOH and top up to 1 litre with water. | |

### Concentrate K-6 (Comparison)

Single-part, single-phase colour paper colour developing concentrate, produced as described in example 1 of U.S. Pat. No. 6,077,651.

Further comparison examples and colour developing concentrates according to the invention were produced by adding the wetting agent indicated in Table 1 to the concentrate called basic concentrate in Table 1 in the amount indicated there at the end of the production process.

TABLE 1

| | | | Amount of | |
|---|---|---|---|---|
| | Basic | Wetting | wetting agent | |
| Concentrate | concentrate | agent | in g/l | |
| VK-1 | K-1 A | None | — | Comparison |
| | K-1 B | | | |
| | K-1 C | | | |
| VK-2 | K-2 | None | — | Comparison |
| VK-3 | K-2 | Lutensol | 5 | Invention |
| | | T08 | | |
| VK-4 | K-2 | Lutensol | 20 | Invention |
| | | T08 | | |
| VK-5 | K-3 | None | — | Comparison |
| VK-6 | K-3 | Lutensol | 5 | Invention |
| | | AP20 | | |
| VK-7 | K-3 | LutensoL | 20 | Invention |
| | | AP20 | | |
| VK-8 | K-4 | None | — | Comparison |
| VK-9 | K-4 | Lutensol | 5 | Invention |
| | | AT 25 | | |
| VK-10 | K-4 | Lutensol | 20 | Invention |
| | | AT 25 | | |
| VK-11 | K-5 | None | — | Comparison |
| VK-12 | K-5 | Lutensol | 0.1 | Invention |
| | | AT 25 | | |
| VK-13 | K-5 | Lutensol | 1 | Invention |
| | | AT 25 | | |
| VK-14 | K-5 | Lutensol | 5 | Invention |
| | | AT 25 | | |
| VK-15 | K-5 | Lutensol | 20 | Invention |
| | | AT 25 | | |
| VK-16 | K-5 | Lutensol | 40 | Invention |
| | | AT 25 | | |
| VK-17 | K-6 | None | — | Comparison |
| VK-18 | K-6 | Lutensol | 5 | Invention |
| | | AT 25 | | |
| VK-19 | K-6 | Lutensol | 20 | Invention |
| | | AT 25 | | |

The wetting agent Lutensol T08, Lutensol AP20 and Lutensol AT25 are commercial products from BASF. Lutensol T08 corresponds to compound (II-2), Lutensol AP20 is a mixture of compounds (IV-4), (IV-9) and (IV-14) and Lutensol AT 25 is a mixture of compounds (I-1), (I-2) and (I-3).

The amount of wetting agent added to concentrate K-16 is so high that a portion of the wetting agent remains undissolved. Such concentrates have the drawback that they have to be homogenised prior to use and are therefore unwanted.

### Example 1

The concentrates according to Table 2 were stored in an air-tight plastic bottle under the conditions given in Table 2 and the extent of precipitation was subsequently assessed visually. The results may be seen in Table 2.

Precipitation judged “average” frequently leads to complaints and may lead to inadequate effect if care is not taken to ensure that all components enter the developer tank where they are also dissolved. Concentrates with heavy precipitation absolutely have to be initially homogenised again prior to use, and this is unacceptable to customers.

TABLE 2

| | Storage | | |
|---|---|---|---|
| | temperature | Storage | |
| Concentrate | in ° C. | duration | Precipitation |
| VK-1 | −7 | 7 days | none |
| VK-2 | −7 | 7 days | average |
| VK-3 | −7 | 7 days | none |
| VK-4 | −7 | 7 days | none |
| VK-5 | −7 | 14 days | average |
| VK-6 | −7 | 14 days | none |
| VK-7 | −7 | 14 days | none |
| VK-8 | −7 | 14 days | heavy |
| VK-9 | −7 | 14 days | none |
| VK-10 | −7 | 14 days | none |
| VK-11 | −7 | 45 days | average |
| VK-12 | −7 | 45 days | average |
| VK-13 | −7 | 45 days | slight |
| VK-14 | −7 | 45 days | none |
| VK-15 | −7 | 45 days | none |
| VK-17 | −7 | 14 days | average |
| VK-18 | −7 | 14 days | none |
| VK-19 | −7 | 14 days | none |

It is clear from the results that only the concentrates according to the invention have outstanding stability in storage at the low, temperatures preferred for storage of colour developing concentrates. After addition of the wetting agent according to the invention a gelling effect is observed which possibly leads to the surprising stability.

### Example 2

A colour photographic recording material was produced by applying the following layers in the given sequence to a substrate made of paper coated with polyethylene on both sides. The amounts relate 1 m² in each case to. The corresponding amounts of AgNO₃ are given for the application of silver halide.

Layer Construction 1

First layer (substrate layer):

0.1 g gelatin

Second layer (blue-sensitive layer):

blue-sensitive silver halide emulsion (99.5 mol-% AgCl, 0.5 mol-% AgBr, mean particle diameter 0.9 μm) consisting of

0.50 g gelatin

0.42 g yellow coupler GB-1

0.18 g yellow coupler GB-2

0.50 g tricresylphosphate (TCP)

0.10 stabiliser ST-1

Third layer (intermediate layer)

1.1 g gelatin

0.06 g scavenger SC-1

0.06 g scavenger SC-2

0.12 g TCP

Fourth layer (green-sensitive layer):

green-sensitive silver halide emulsion (99.5 mol-% AgCl, 0.5 mol-% AgBr, mean particle diameter 0.47 μm) consisting of

0.40 g AgNO₃

0.77 g gelatin

0.21 g magenta coupler PP-1

0.15 g magenta coupler PP-2

0.05 g magenta coupler PP-3

0.06 g colour stabiliser ST-2

0.12 g scavenger SC2

0.23 g dibutylphthalate

Fifth layer (UV protective layer):

1.15 g gelatin

0.03 g scavenger SC-1

0.03 g scavenger SC-2

0.5 g UV-absorber UV-1

0.10 g UV-absorber UV-2

0.35 g TCP

Sixth layer (red-sensitive layer):

red-sensitive silver halide emulsion (99.5 mol-% AgCl, 0.5 mol-% AgBr, mean particle diameter 0.5 μm) consisting of

0.30 g AgNO₃ mit

1.0 g gelatin

0.40 g cyan coupler BG-1

0,05 g cyan coupler BG-2

0,46 g TCP

Seventh layer (UV protective layer):

0.35 g gelatin

0.15 g UV-1

0.03 g UV-2

0.09 g TCP

Eighth layer (protective layer)

0.9 g gelatin

0.3 g curing agent HM

0.05 g optical brightener W-1

0.07 g vinylpyrrolidon

1.2 mg silicone oil

2.5 mg polymethylmethacrylate microspheres with a mean particle diameter of 0.8 μm

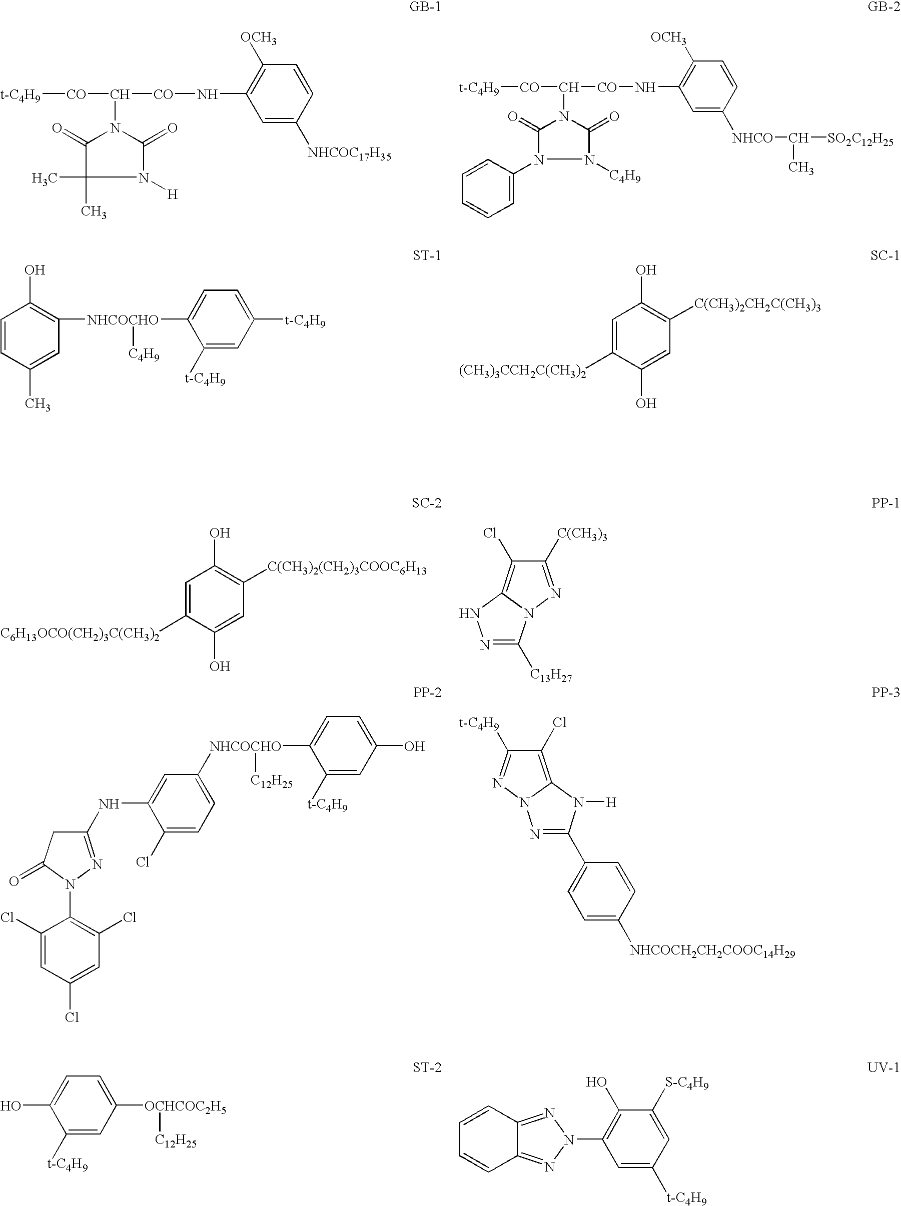

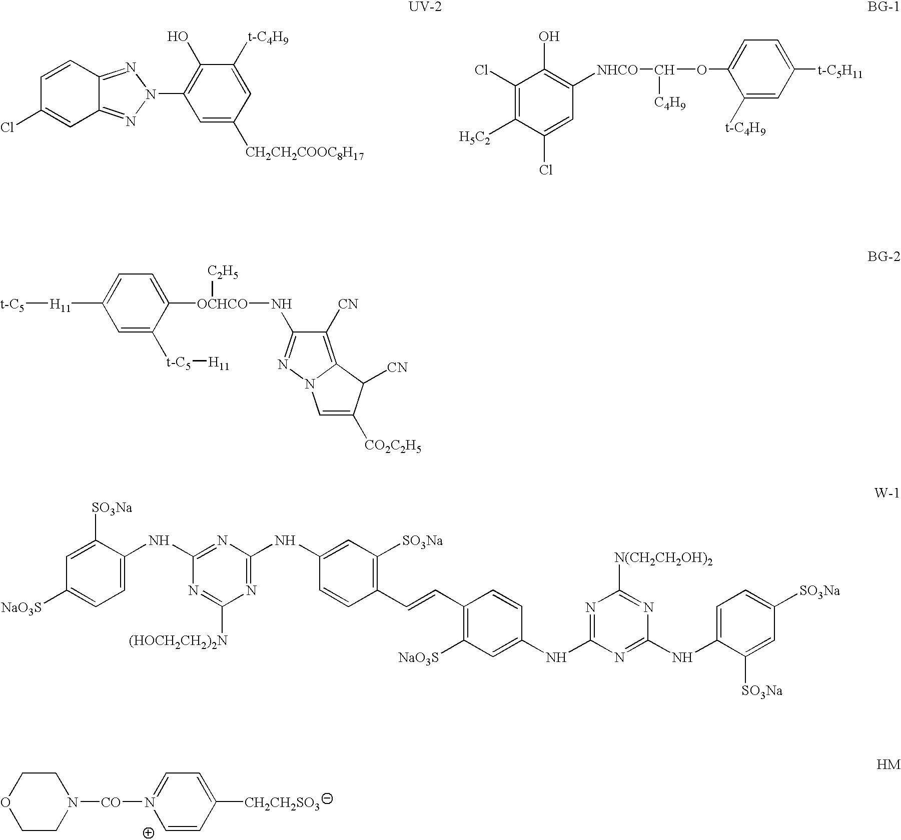

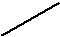

The colour photographic recording material is exposed and processed under the following conditions:

| Step | Time | Regeneration quota | Temperatures |
|---|---|---|---|
| Developing | 33 sec | 60 ml/m² | 40° C. |
| Bleach fixing | 33 sec | 100 ml/m² | 38° C. |
| Stabilising | 88 sec | 200 ml/m² | 38° C. |

Ready-to-use developers from the concentrates given in Table 3 were used as colour developer.

Bleach fixing bath

| | |
|---|---|
| Ammoniumthiosulphate solution, 58% by weight | 100 ml |
| Sodium disulphite | 5 g |
| Ammonium iron EDTA, 48% by weight | 100 ml |

topped up to 1,000 ml with water, pH adjusted to 6.0 with ammonia or acetic acid.

Stabilising bath

| | |
|---|---|
| Water | 900 ml |
| Sodiumsulphite | 2 g |
| Hydroxyethanediphosphonic acid disodium salt | 4 g |
| Sodiumbenzoate | 0.5 g |

topped up to 1,000 ml with water, pH adjusted to 5 with acetic acid.

Drying

65° C., 1 min

Material was developed in a photographic processing machine with the described recording material until the baths were in a state of equilibrium. In the process the initial developing solution was prepared from developing concentrate VK-2 and this concentrate was also used to prepare the developer regenerator. After reaching the state of equilibrium optical brightener precipitations were observed in the bleach fixing bath tank solution. A sample of the bleach fixing bath was taken from the machine and stored in an open beaker at about 10° C. Even after one day the amount of precipitated optical brightener had clearly increased.

The test was then repeated with the difference that the developer regenerator was prepared from concentrate VK-3. No precipitation was observed this time after reaching the state of equilibrium. The bleach fixing bath sample removed and stored at 10° C. did not show any precipitation after a storage period of 10 days either.

A third test was carried out as described above but with the difference that the initial developing solution was prepared from the surfactant-containing developing concentrate VK-3 and the developer regenerator from the surfactant-free concentrate VK-2.

After reaching the state of equilibrium optical brightener precipitation was observed in the bleach fixing bath tank solution. In the sample removed and treated as described above the amount of precipitated optical brightener had clearly increased even after one day.

The tests clearly show that optical brightener precipitation in the bleach fixing bath may only be avoided by wetting agent-containing concentrates or regenerating solutions.

### Example 3

The concentrates given in Table 3 were diluted with water in the ratio 1 ml concentrate to 8 ml water and then introduced into a bleach fixing bath regenerator with the same volume to readjust a used bleach fixing bath tank charge.

The solution obtained was stored for 1 day in the open beaker at the temperatures given in Table 3 and the optical brightener precipitation was then observed. The qualitative results of observation are also to be found in Table 3.

Formulation of the bleach fixing bath regenerator:

| | |
|---|---|
| Water | 700 ml |
| Ammonium sulphate | 100 g |
| Sodium sulphite | 20 g |
| NH₄Fe-EDTA | 80 g |
| Acetic acid | 15 g |

The mixture was adjusted to pH 6.5 with ammonia and topped up to 1 litre with water.

TABLE 3

| | CD concentrate for | | Optical |
|---|---|---|---|
| | tank preparation | | brightener |
| Test No. | from | Storage at | precipitation |
| 1 | VK-1 | 10° C. | yes |
| 2 | VK-1 | 35° C. | yes |
| 3 | VK-2 | 10° C. | yes |
| 4 | VK-2 | 35° C. | yes |
| 5 | VK-3 | 10° C. | no |
| 6 | VK-3 | 35° C. | no |
| 7 | VK-4 | 10° C. | no |
| 8 | VK-4 | 35° C. | no |
| 9 | VK-5 | 10° C. | yes |
| 10 | VK-5 | 35° C. | yes |
| 11 | VK-6 | 10° C. | a little |
| 12 | VK-6 | 35° C. | no |
| 13 | VK-7 | 10° C. | no |
| 14 | VK-7 | 35° C. | no |
| 15 | VK-8 | 10° C. | yes |
| 16 | VK-8 | 35° C. | yes |
| 17 | VK-9 | 10° C. | no |
| 18 | VK-9 | 35° C. | no |
| 19 | VK-10 | 10° C. | no |
| 20 | VK-10 | 35° C. | no |
| 21 | VK-11 | 10° C. | yes |
| 22 | VK-11 | 35° C. | yes |
| 23 | VK-12 | 10° C. | yes |
| 24 | VK-12 | 35° C. | yes |
| 25 | VK-13 | 10° C. | yes |
| 26 | VK-13 | 35° C. | a little |
| 27 | VK-14 | 10° C. | no |
| 28 | VK-14 | 35° C. | no |
| 29 | VK-15 | 10° C. | no |
| 30 | VK-15 | 35° C. | no |
| 31 | VK-17 | 10° C. | yes |
| 32 | VK-17 | 35° C. | yes |
| 33 | VK-18 | 10° C. | no |
| 34 | VK-18 | 35° C. | no |
| 35 | VK-19 | 10° C. | no |
| 36 | VK-19 | 35° C. | no |

Table 3 shows clearly that optical brightener precipitation in the bleach fixing bath may only be effectively prevented by addition of suitable wetting agent concentrations to the colour developing concentrate.

### Example 4

The runout behaviour of the concentrates was tested. For this purpose, the concentrates VK-1 to VK-19 were tested upside down with respect to the runout behaviour from 1 litre PE bottles. The criterion of the test was the weighed residual amount of concentrate after a runout time of 5 min at about 20° C. The results are summarised in Table 4.

TABLE 4

| | Residual amount |
|---|---|
| Concentrate | in g |
| VK-1 | 6.25 |
| VK-2 | 4.17 |
| VK-3 | 1.53 |
| VK-4 | 1.08 |
| VK-5 | 3.98 |
| VK-6 | 1.71 |
| VK-7 | 1.11 |
| VK-8 | 4.35 |
| VK-9 | 1.65 |
| VK-10 | 1.02 |
| VK-11 | 4.47 |
| VK-12 | 3.15 |
| VK-13 | 2.24 |
| VK-14 | 1.61 |
| VK-15 | 0.99 |
| VK-17 | 4.52 |
| VK-18 | 1.73 |
| VK-19 | 1.04 |

It may clearly be seen that, owing to the addition according to the invention of a wetting agent, the residual amount remaining in the concentrate bottle after emptying is greatly reduced, in particular with single-part colour developing concentrates, whereby the disposal thereof is considerably facilitated.

### Example 5

The soiling of a processing machine with automatic docking procedure was tested. For this purpose the developing concentrate was inserted as part of a packing drum consisting of a plurality of processing chemicals, in accordance with Table 5, and the soiling visually assessed once five packing drums had been consumed. In the assessment reproduced in Table 5 “heavy” represents soiling which may considerably disturb operation of the equipment, “medium” represents soiling which is clearly visible but may still be tolerated and “none” represents slightly visible to invisible soiling.

TABLE 5

| Concentrate | Soiling |
|---|---|
| VK-1 | medium |
| VK-2 | heavy |
| VK-3 | medium |
| VK-4 | none |
| VK-5 | heavy |
| VK-6 | medium |
| VK-7 | none |
| VK-8 | heavy |
| VK-9 | medium |
| VK-10 | none |
| VK-11 | heavy |
| VK-12 | medium |
| VK-13 | medium |
| VK-14 | medium |
| VK-15 | none |
| VK-17 | heavy |
| VK-18 | medium |
| VK-19 | none |

It may clearly be seen that, owing to the addition according to the invention of a wetting agent, soiling of the equipment by residues of single-part colour developing concentrates may be prevented whereby the entire packing drum may be disposed of inexpensively.

1. Single-part colour developing concentrate with a pH greater than or equal to 7 which contains at least 0.02 mol of a colour developer substance and at least 0.015 mol of an antioxidant per litre, characterised in that the concentrate contains 0.05 to 35 g per litre of a wetting agent which is water-soluble in this amount.

2. Colour developing concentrate according to claim 1, characterised in that it contains at least 0.06 mol of a colour developer substance and at least 0.05 mol of an antioxidant per litre.

3. Colour developing concentrate according to claim 1, characterised in that the colour developer substance is 4-(N-ethyl-N-2-methyl-sulphonylaminoethyl)-2-methylphenylenediamine.

4. Single-part colour developing concentrate according to claim 1, characterised in that the wetting agent is non-ionic.

5. Method for processing a colour photographic silver halide material, characterised in that the developing solution is prepared from a concentrate and/or is regenerated with a concentrate in which the concentrate is a single-part colour developing concentrate with a pH greater than or equal to 7, which contains at least 0.02 mol of a colour developer substance and at least 0.015 mol of an antioxidant per litre, characterised in that the concentrate contains at least 0.05 g per litre of a wetting agent which is water-soluble in this amount.

6. Method according to claim 5, characterised in that the developing solution has a temperature between 20 and 50° C.

7. Method according to claim 5, characterised in that the regeneration quota of the developing solution is less than 120 ml per m² of processed material.

8. Method according to claim 5, characterised in that the developing time is less than 60 s.
